(19) United States
(12) Patent Application Publication
(10) Pub. No.: US 2014/0190717 A1
(43) Pub. Date: Jul. 10, 2014

(54) Resilient Cover For Power Tool

(71) Applicant: Black & Decker Inc., Newark, DE (US)

(72) Inventor: Mike Simpson, Surrey (GB)

(73) Assignee: Black & Decker Inc., Newark, DE (US)

(21) Appl. No.: 14/147,695

(22) Filed: Jan. 6, 2014

(30) Foreign Application Priority Data
Jan. 7, 2013 (GB) 1300211.8

(51) Int. Cl. B25F 5/02

(52) U.S. Cl. CPC B25F 5/02
USPC 173/216; 29/428

(57) ABSTRACT

A power tool includes a housing having a horizontal part of that contains a motor and gear set, and a vertical part having a handle extending from the horizontal part generally transverse to the horizontal part. A cover includes a generally tubular body having an internal shape corresponding to an external shape of the horizontal part of the housing, an end cap portion sealing a rear end of the tubular body, a first aperture defined in a front end of the tubular body, and a second aperture defined in a bottom side wall of the body section. The cover is formed of a resilient deformable material so that when mounted on the power tool, a front end portion of the horizontal part extends through the first aperture, the vertical part extends through the second aperture, and the tubular body stretches to frictionally engage an outer surface of the horizontal part of the housing in order to retain the cover on the housing.

### CROSS REFERENCE TO RELATED APPLICATIONS

This application claims priority, under 35 U.S.C. §119, to UK Patent Application No. 13 002 11.8, filed Jan. 7, 201, which is incorporated herein by reference.

### TECHNICAL FIELD

This application relates to a resilient cover for a power tool and in particular to a resilient cover that can be used as an advertising wrap for a power tool such as a drill or driver.

### BACKGROUND

Power tools typically comprise a housing in which is located a motor (usually an electric or pneumatic motor), a tool holder mounted on the housing for holding a cutting tool and a mechanical drive, also located within the housing, which transmits the rotary drive of the motor to the cutting tool to impart rotary and/or reciprocating movement of the cutting tool, and a handle extending transverse to the housing.

A problem with power tools is that it is difficult to change their appearance once they have been manufactured. Sometimes it is desirable to alter their appearance, for example, to refresh the look of the tool, or to add a new or replace an existing logo or trade mark on the tool, or to add information such as safety warnings or operating instructions.

Often power tools are manufactured in bulk and therefore making small batches in a particularly stylized form is incompatible with the manufacturing process or adds substantial cost and complexity. However, it is sometimes desirable to do this, for example, when making a limited edition for a particular customer.

### SUMMARY

In an aspect, a cover is disclosed for a power tool having a housing with a horizontal part that contains a motor and gear set and a vertical part having a handle extending from the horizontal part generally transverse to the horizontal part. The cover includes a generally tubular body having an internal shape corresponding to an external shape of the horizontal part of the housing, an end cap portion sealing a rear end of the tubular body, a first aperture defined in a front end of the tubular body, and a second aperture defined in a bottom side wall of the body. The cover is formed of a resilient deformable material so that when mounted on the power tool, a front end portion of the horizontal part of the housing extends through the first aperture, the vertical part extends through the second aperture, and the cover stretches to frictionally engage an outer surface of the horizontal part of the housing in order to retain the cover on the housing.

Implementations of this aspect may include one or more of the following features. The body may include a plurality of additional apertures that align with predetermined regions of the outer surface of the horizontal part of the housing when the cover is mounted on the power tool. The predetermined areas may include at least one of an air vent, a switch, and a recessed area that includes a logo or other information about the power tool. An external shape of the cover may mirror the external shape of the horizontal part of the housing, or may be different from the external shape of the horizontal part of the housing. Internal dimensions of the internal shape of the cover may be smaller than external dimensions of the horizontal part of the housing so that the cover stretches when mounted to the housing. The cover may include an outer surface with a logo or other printed information. The cover may be manufactured with a one piece construction. The cover may have a color that is different from a color of the outer surface of the housing. The cover may include a strap integral and at the front end of the body. The strap may be configured to be received over a switch housing of the power tool disposed between the horizontal part and the vertical part of the housing.

In another aspect, a combination of a power tool and a cover for the power tool is disclosed. The power tool includes a housing having a horizontal part of that contains a motor and gear set, and a vertical part having a handle extending from the horizontal part generally transverse to the horizontal part. The cover includes a generally tubular body having an internal shape corresponding to an external shape of the horizontal part of the housing, an end cap portion sealing a rear end of the tubular body, a first aperture defined in a front end of the tubular body, and a second aperture defined in a bottom side wall of the body section. The cover is formed of a resilient deformable material so that when mounted on the power tool, a front end portion of the horizontal part extends through the first aperture, the vertical part extends through the second aperture, and the tubular body stretches to frictionally engage an outer surface of the horizontal part of the housing in order to retain the cover on the housing.

Implementations of this aspect may include one or more of the following features. The cover may include a plurality of additional apertures that align with predetermined regions of the outer surface of the horizontal part of the housing when the cover is mounted on the housing. The predetermined areas may include at least one of an air vent, a switch, and a recessed area that includes a logo or other information about the power tool. The external shape of the cover may mirror the external shape of the horizontal part of the housing, or may be different from the external shape of the horizontal part of the housing. Internal dimensions of the internal shape of the body are smaller than external dimensions of the horizontal part of the housing so that the cover stretches when mounted to the housing. The cover may include an outer surface with a logo or other printed information. The cover may be manufactured with a one piece construction. The cover may have a color that is different from a color of the outer surface of the housing. The cover may include a strap integral and at the front end of the body. The strap may be configured to be received over a switch housing of the power tool disposed between the horizontal part and the vertical part of the housing.

In another aspect, a method of installing a cover on a power tool is disclosed. A power tool is provided with a housing having a horizontal part that contains a motor and gear set, and a vertical part having handle extending from the horizontal part generally transverse to the horizontal part. A cover is provided composed of a resilient deformable material. The cover includes a generally tubular body having an internal shape corresponding to an external shape of the horizontal part of the housing, an end cap portion sealing a rear end of the tubular body, a first aperture defined in a front end of the tubular body, and a second aperture defined in a bottom side wall of the body section. A front end of the housing is inserted through the second aperture, and then through the first aperture. The end cap is wrapped around a rear part of the horizontal part of the housing by stretching the cover over the horizontal part of the housing, so that the handle extends through the second aperture. In one implementation of this aspect, the cover may include a strap disposed adjacent the front end of the body that is wrapped around a switch housing of the power tool, where the switch housing is disposed between the horizontal portion and the vertical portion of the housing.

Advantages may include on or more of the following. The cover may enable a manufacturer, seller, or user to change the appearance of the power tool housing after the power tool has been manufactured or sold (e.g., to refresh the look of the tool, or to add a new or replace an existing logo or trade mark on the tool, or to add information such as safety warnings or operating instructions). This may enable manufacturers and sellers to manufacture power tools in bulk, and then change the appearance of small batches of power tools (e.g., when making a limited edition for a particular customer). The cover may also reduce breakage of the plastic components of the housing. Further, the cover may dampen or reduce noise emitted from the power tool during use. These and other advantages and features will be apparent from the description, the drawings, and the claims.

### BRIEF DESCRIPTION OF THE DRAWINGS

FIG. 1 is a side view of a drill/driver.

FIGS. 2A and 2B are side views of a first embodiment of a removeably mountable resiliently deformable cover.

FIGS. 3A and 3B are side views of a second embodiment of a removeably mountable resiliently deformable cover.

FIGS. 4A and 4B are top and side views respectively of a drill/driver with a third embodiment of a removeably mountable resiliently deformable cover.

FIGS. 5A and 5B are top and side views respectively of a drill/driver with a fourth embodiment of a removeably mountable resiliently deformable cover.

### DETAILED DESCRIPTION

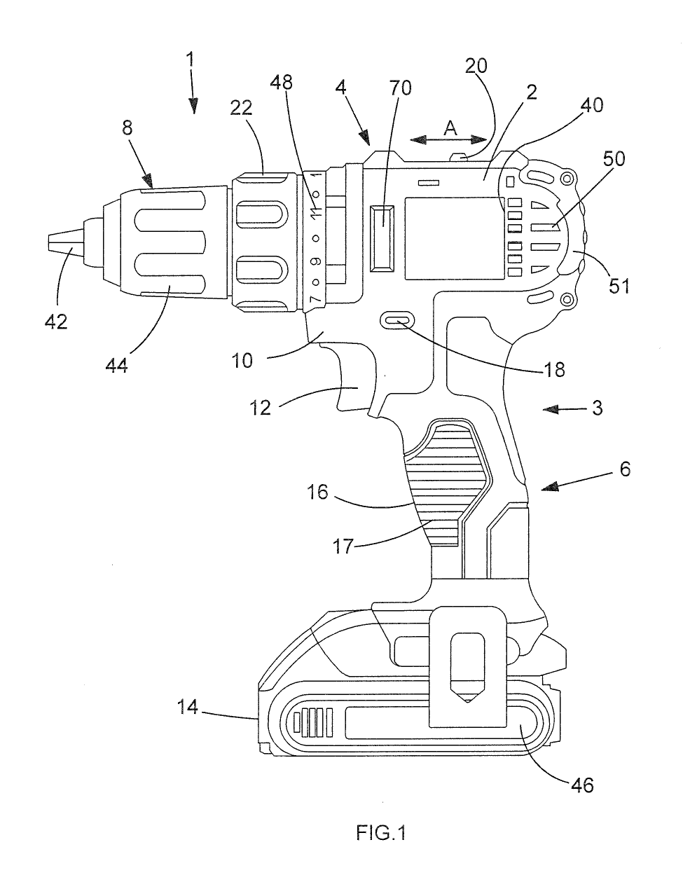

Referring to FIG. 1, in one embodiment, a drill/driver 1 comprises a housing 2 formed from a number of hard plastic clam shells which may be attached to each other by a number of screws (not shown). The housing 2 comprises a generally horizontal tubular top section 4 in which is located an electric motor (not shown) and a gear set (not shown). In one example, the housing may have a yellow color. A generally vertical tubular section 6 connects to the underside of and extends generally transverse to the horizontal section 4. The generally vertical section 6 is shaped to accommodate a hand of an operator in order to form a handle 16 by which an operator can support the drill/driver. The vertical tubular section 6 and the rear of the horizontal tubular section may be covered by an overmold 17, e.g., made from a rubber or elastomeric material, which is non removeably attached to the hard plastic clam shells. In one example, the overmold 17 may have a color that contrasts with the color of the housing, e.g., black. Formed in the side of the housing 2 in the horizontal tubular top section 4 is a recess 40 in which is located, in a fixed manner, a label on which the brand name of the manufacturer and the name of the particular product is printed. A rectangular bumper 70 (e.g., made of a rubber or elastomeric material) may be attached to and protrude from the housing 2 adjacent the recess 40. The bumper may have a contrasting color to the housing, e.g., black.

Attached to an output spindle of the gear set which projects from a forward end of the horizontal section 4, is a chuck 8 which is capable of supporting a cutting tool such as a drill bit. The chuck comprises jaws 42 for holding the cutting or driving tool accessory and a rotatable plastic sleeve 44 for adjusting the position of the jaws in well known manner. The housing 2 further comprises a switch housing 10 in which is mounted an electric switch (not shown) which can be activated by depression of a trigger 12 connected to the electric switch and which is slideably mounted within an aperture form in the wall of the housing 2.

A battery pack 14 is releaseably attached to a socket formed within the lower end of the vertical section 6. The battery pack 14, when located within the socket, is in electrical connection with the switch via a first set of electric wires (not shown) located inside of the vertical section 6, the switch being in electrical connection with the motor via a second set of electric wires (not shown). Depression of the trigger 12 provides an electrical connection between the battery and the motor, activating the motor, causing the motor to rotate. The housing of the battery pack 14 may be made from plastic, and may have the same color as the housing, e.g., yellow. Formed in the side of the housing of the battery pack 14 is a recess 46 in which is located, in a fixed manner, a label on which the name of the particular type of battery and/or the brand or manufacturer is printed.

A slider switch 18 is mounted adjacent the button 12 within a second aperture formed through the wall of the housing which can be axially slid between two positions. The slider switch 18 is connected to the electric switch. When the slider switch 18 is in its first position, depression of the trigger 12 causes the motor to rotate in a first forward direction. When the slider switch 18 is in its second position, depression of the button causes the motor to rotate in a second reverse direction. Use of the slider switch 18 enables the operator to alter the direction of rotation of the chuck 8 by the motor.

When the motor is activated, the drive spindle of the motor rotationally drives the gears within the gear set, which in turn rotationally drives the output spindle of the gear set, which in turn rotationally drives the chuck 8. The rotational speed of the drive spindle of the motor is reduced by the gear set so that the rotational speed of the output spindle is less than that of the drive spindle. The amount by which the speed is reduced can be adjusted between two different speed settings. Located within a third aperture formed through a top wall of the housing 2 is a sliding speed selector switch 20. The sliding speed selector switch 20 connects to the gear set. The speed selector switch 20 can be slid in a forward and reverse manner (Arrow A) within the aperture between two positions, each position resulting in the gear set reducing the rotational speed of the motor by a different amount.

The gear set also comprises an adjustable torque clutch (not shown) by which rotational movement of the drive spindle is transferred to the output spindle. When an excessive torque is place on the output spindle, the torque clutch is able to slip, allowing the drive spindle of the motor to continue rotating whilst the output spindle remains stationary, thus preventing damage to motor and prevent an unwanted twisting movement of the housing 2 due to kick back. The torque setting of the clutch can be adjusted using a plastic collar 22 rotationally mounted on the forward end of the horizontal section 4 of the housing 2. Rotational movement of the collar 22 adjusts the torque setting. A series of numbers 48 may be printed or embossed on the collar 22, indicating the torque setting of the collar 22. The collar may have a contrasting color to the color of the housing, e.g., black, while the numbers may have the same color as the color of the housing, e.g., yellow.

When the motor is activated, it generates a large amount of heat. Therefore a fan (not shown) is mounted on the drive spindle of the motor. As the drive spindle rotates, the fan rotates drawing air over the motor. Vents 50 are formed through the rear end of the horizontal section 4 through which the hot air is expelled from the inside of the housing 2.

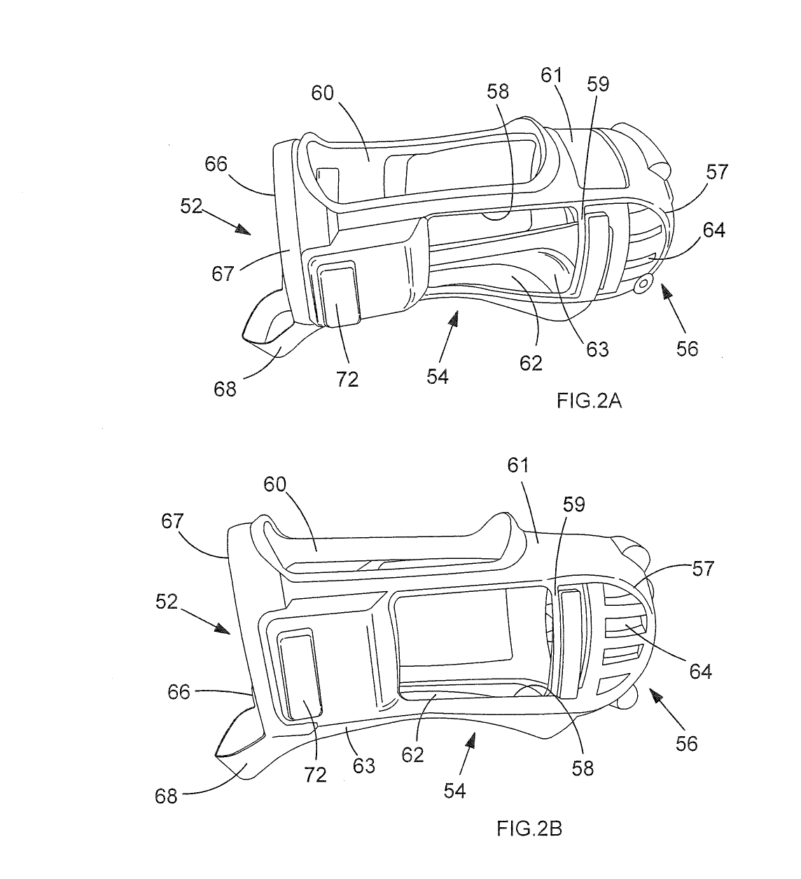

FIGS. 2A and 2B show side views of a first embodiment of a removeably mountable resilient cover 52 for the power tool housing. The cover 52 is made from an elastomeric material, e.g. rubber. The cover 52 may have a contrasting color to the color of the housing, e.g., black. The resilient deformable cover 52 may be utilized for the printing or addition of advertising material to the housing of the drill/driver. The resiliently deformable cover 52 is capable of being releasably mounted onto a part the horizontal section 4 of the housing of drill driver.

The resiliently deformable cover 52 is manufactured in a one piece construction and comprises a generally tubular body section 54 with one end 56 sealed by an end cap 57, and a series of apertures 58, 60, 62, 64, 66 fowled through side walls of the body section 54. The first aperture 58 is defined in a right side wall 59 of the body section 54, and is dimensioned and positioned so that the first aperture 58 locates over the recess 40 formed in the housing 2 of the drill/driver and exposes it so that the label within it remains visible when the cover is located on the housing 4 of the drill driver. It will be appreciated however that the first aperture 58 could be closed to conceal a label attached to a drill/driver.

The second aperture 60 is defined in the top side wall 61 of the body section 54, and is dimensioned and positioned so that it locates around the sliding speed selector switch 20, and allows the switch 20 to be slid freely between its two positions by an operator. The third aperture 62 is defined in the bottom side wall 63 of the body section 54, and is dimensioned and positioned so that the handle 16 of the drill/driver can extend through it. The fourth aperture 64 is defined in the end cap 56 and is dimensioned and positioned so that it locates over the air vents 50 formed in the housing 2 of the drill/driver, leaving them fully exposed (and therefore visible) so that the cover 52 does not interfere with the air passing through the vents 50 and therefore operation of the drill/driver which would result in it over heating.

The fifth aperture 66 is defined in the front end 67 of the body section 54 and is dimensioned and positioned so that the front part of the horizontal section 4 of the drill/driver housing 2 can extend through the fifth aperture 66 and allow the chuck to locate forward of the cover 52. A strap 68 formed at a lower edge of the fifth aperture 66 wraps around the switch housing 10 of the drill driver.

The internal shape of the cover 52 is formed so that it is similar to or corresponds directly with the external shape of the horizontal section 4 of the drill/driver housing 2 on which it is mounted, with dimensions slightly smaller so that the cover 52 remains in a slightly stretched condition when located on the drill/driver housing 2. This provides frictional engagement between the cover 52 and the housing 2 of the drill/driver, which ensures that the resilient nature of the cover 52 is utilized to secure the cover to the drill/driver housing 2 and to allow the drill/driver to be used with the cover 52 attached. The resilient material of the cover may also dampen the amount of noise emitted by the operation of the drill/driver.

The external shape of the cover 52 can mirror the internal shape of the cover 52, so that features of the external shape of the drill/driver are replicated on the cover. For example, the internal shape of the cover 52 may include a rectangular recess for accommodating the bumper 70 on the drill driver housing 2, while the external shape of the cover 52 may mirror this and include a rectangular projection 72 located adjacent to the recess 40 and protecting from the side of the cover 52. In this embodiment, the resilient nature of the cover 52 may improve the performance of the bumper 70. Alternatively, the external shape of the cover 52 can be different to that of the internal shape, so that the addition of the cover 52 to the drill/driver provides an apparent alternative shape for the power tool housing.

In order to locate the cover 52 onto the drill/driver, the chuck 8 and the front part of the horizontal section 4 of the housing 2 are first passed through the third aperture 62 and then through the fifth aperture 66 so that the handle extends through the third aperture 62, the cover 52 stretching as it does so. The strap 68 wraps around the switch housing 10. Then the end cap 56 is wrapped around the rear part 51 of the horizontal section 4 of the drill/driver housing 2, by stretching the cover over the housing 2. The apertures formed through the cover locate adjacent their corresponding features on the drill/driver, as described above. The cover remains slightly stretched once located on the drill/driver to secure it in place. To remove the cover, the end cap 56 is removed from the rear part of the horizontal section by stretching it over the rear part. The chuck 8 and the front part of the horizontal section are then passed through the fifth aperture 6 and through the third aperture 62.

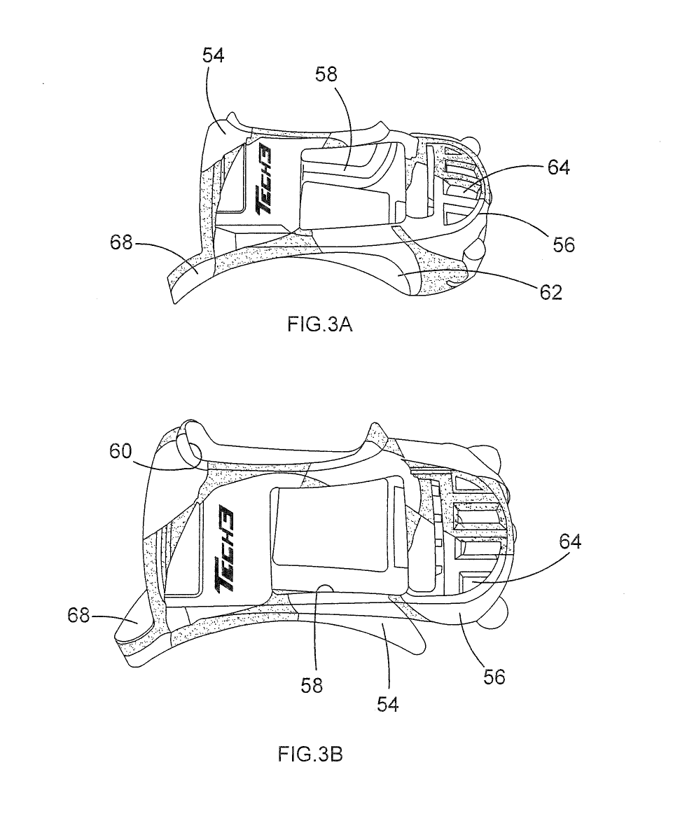

Referring to FIGS. 3A and 3B, in a second embodiment, in order to use the cover as an advertising wrap, logos and/or information, such as text can be added to the external surface of the cover, thus enabling additional information or advertisements to be added to the drill/driver for the operator's benefit. For example, FIGS. 3A and 3B show such covers with a TECH3 logo added (TECH3 is a trade mark owned by Tech3 Sarl). Where the same features as the first embodiment are shown, the same reference numbers are used. The main different between the second embodiment and the first embodiment is that the cover is may have a white color with a black pattern, and may include an advertising logo or message. This enables part of the color of the drill/driver housing to be altered and to add logos to the drill/driver after the completion of the manufacture of the drill/driver. In addition, or alternatively, text, for example, safety information or operating instructions can be located on the cover enabling this addition text to be added to the product after it has been manufactured (for example to make the drill/driver compliant with new safety legislation which came into force after the manufacture of the drill/driver). The color of the cover, the logos and text can be integrally molded into the cover, or printed externally onto the cover. The addition of a cover with logos and/or text enables the cover to act as an advertising wrap.

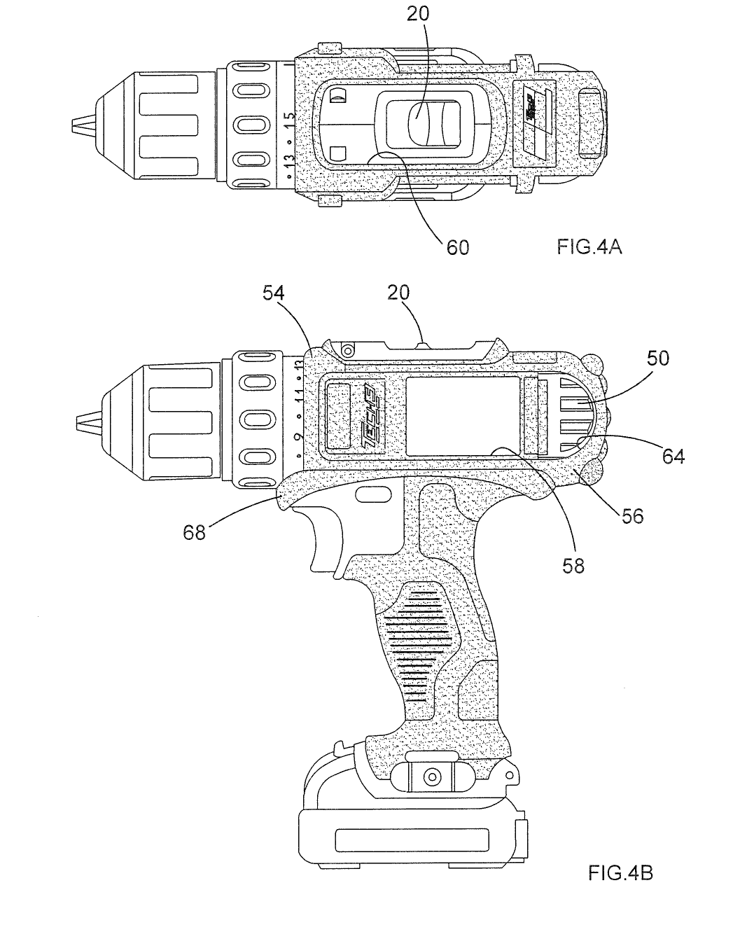

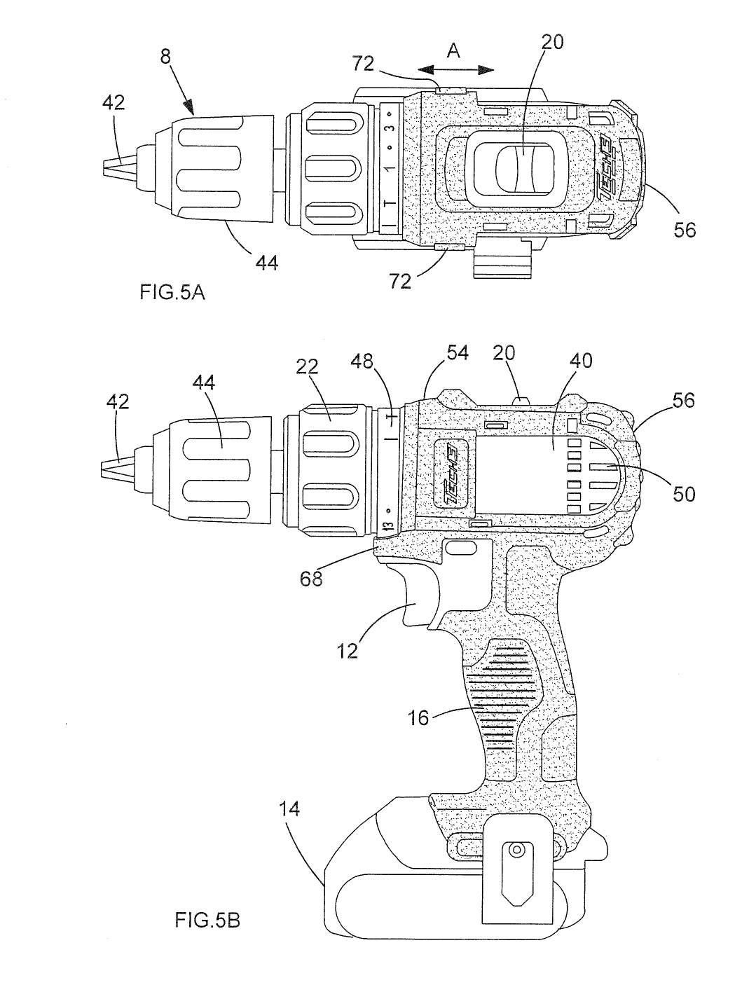

FIGS. 4A and 4B show a third embodiment of a removeably mountable resiliently deformable cover mounted on a drill/driver, where like reference numerals indicate the same features as the first embodiment. FIGS. 5A and 5B show a fourth embodiment of a removeably mountable resiliently deformable cover mounted on a drill/driver, where like reference numerals indicate the same features as the first embodiment. The main different between the third and fourth embodiments and the first embodiment is that the third and fourth embodiments each have a logo located thereupon and have apertures of a different shape and in different locations than the first embodiment.

Numerous modifications may be made to the exemplary implementations described above. These and other implementations are within the scope of the following claims.

What is claimed is:

1. A cover for a power tool having a housing with a horizontal part that contains a motor and gear set and a vertical part having a handle extending from the horizontal part generally transverse to the horizontal part, the cover comprising:
a generally tubular body having an internal shape corresponding to an external shape of the horizontal part of the housing;
an end cap portion sealing a rear end of the tubular body;
a first aperture defined in a front end of the tubular body; and
a second aperture defined in a bottom side wall of the body,
wherein the cover is formed of a resilient deformable material so that when mounted on the power tool, a front end portion of the horizontal part of the housing extends through the first aperture, the vertical part extends through the second aperture, and the cover stretches to frictionally engage an outer surface of the horizontal part of the housing in order to retain the cover on the housing.

2. The cover of claim 1, wherein the body comprises a plurality of additional apertures that align with predetermined regions of the outer surface of the horizontal part of the housing when the cover is mounted on the power tool, the predetermined areas comprising at least one of an air vent, a switch, and a recessed area that includes a logo or other information about the power tool.

3. The cover of claim 1, wherein an external shape of the cover mirrors the external shape of the horizontal part of the housing.

4. The cover of claim 1, wherein the external shape of the cover is different from the external shape of the horizontal part of the housing.

5. The cover of claim 1, wherein internal dimensions of the internal shape of the cover are smaller than external dimensions of the horizontal part of the housing so that the cover stretches when mounted to the housing.

6. The cover of claim 1, wherein the cover includes an outer surface with a logo or other printed information.

7. The cover of claim 1, wherein the cover is manufactured with a one piece construction.

8. The cover of claim 1, wherein the cover has a color that is different from a color of the outer surface of the housing.

9. The cover of claim 1 further comprising a strap integral and at the front end of the body, the strap configured to be received over a switch housing of the power tool disposed between the horizontal part and the vertical part of the housing.

10. A combination comprising:
a power tool including a housing having a horizontal part of that contains a motor and gear set, and a vertical part having a handle extending from the horizontal part generally transverse to the horizontal part; and
a cover including a generally tubular body having an internal shape corresponding to an external shape of the horizontal part of the housing, an end cap portion sealing a rear end of the tubular body, a first aperture defined in a front end of the tubular body, and a second aperture defined in a bottom side wall of the body section,
wherein the cover is formed of a resilient deformable material so that when mounted on the power tool, a front end portion of the horizontal part extends through the first aperture, the vertical part extends through the second aperture, and the tubular body stretches to frictionally engage an outer surface of the horizontal part of the housing in order to retain the cover on the housing.

11. The combination of claim 10, wherein the cover comprises a plurality of additional apertures that align with predetermined regions of the outer surface of the horizontal part of the housing when the cover is mounted on the housing, the predetermined areas comprising at least one of an air vent, a switch, and a recessed area that includes a logo or other information about the power tool.

12. The combination of claim 10, wherein an external shape of the cover mirrors the external shape of the horizontal part of the housing.

13. The combination of claim 10, wherein the external shape of the cover is different from the external shape of the horizontal part of the housing.

14. The combination of claim 10, wherein internal dimensions of the internal shape of the body are smaller than external dimensions of the horizontal part of the housing so that the cover stretches when mounted to the housing.

15. The combination of claim 10, wherein the cover includes an outer surface with a logo or other printed information.

16. The combination of claim 10, wherein the cover is manufactured with a one piece construction.

17. The cover of claim 1, wherein the cover has a color that is different from a color of the outer surface of the housing.

18. The cover of claim 1 further comprising a strap integral and at the front end of the body, the strap configured to be received over a switch housing of the power tool disposed between the horizontal part and the vertical part of the housing.

19. A method of installing a cover on a power tool, the method comprising:
providing a power tool having a housing with a horizontal part that contains a motor and gear set, and a vertical part having handle extending from the horizontal part generally transverse to the horizontal part;
providing a cover composed of a resilient deformable material, the cover including a generally tubular body having an internal shape corresponding to an external shape of the horizontal part of the housing, an end cap portion sealing a rear end of the tubular body, a first aperture defined in a front end of the tubular body, and a second aperture defined in a bottom side wall of the body section;
inserting a front end of the housing through the second aperture, and then through the first aperture;
wrapping the end cap around a rear part of the horizontal part of the housing by stretching the cover over the horizontal part of the housing, so that the handle extends through the second aperture.

20. The method of claim 19, wherein the cover further comprises a strap disposed adjacent the front end of the body, and the method further comprises wrapping the strap around a switch housing of the power tool that is disposed between the horizontal portion and the vertical portion of the housing.
